(19) United States
(12) Patent Application Publication
(10) Pub. No.: US 2010/0060002 A1
(43) Pub. Date: Mar. 11, 2010

(54) WIND TURBINE DIRECT CURRENT CONTROL SYSTEM AND METHODS

(75) Inventor: Christopher W. Gabrys, Reno, NV (US)

Correspondence Address: HOLLAND & HART, LLP, P.O BOX 8749, DENVER, CO, 80201, US

(73) Assignee: MARIAH POWER, INC., Reno, NV (US)

(21) Appl. No.: 12/534,020

(22) Filed: Jul. 31, 2009

Related U.S. Application Data
(60) Provisional application No. 61/137,637, filed on Aug. 1, 2008.

(51) Int. Cl. F03D 7/00; F03D 9/00

(52) U.S. Cl. 290/44

(57) ABSTRACT

A wind turbine control system converts AC power generated by the wind turbine to DC power for use in a load. The control system may include a plurality of modules that convert the AC power to DC power. The control system may include a turbine module that converts the AC power produced by a generator of the wind turbine to DC power. The turbine module may also include a boost converter that boosts the DC current to a higher voltage that improves efficient transfer of the DC power to the load. The control system may further include an output module having a buck converter that bucks the voltage of the DC power to a level needed for use by the load. The control system may control the amount of power generated by the wind turbine based on power needs of the load.

### CROSS REFERENCE TO RELATED APPLICATION

The present application claims the benefit of the filing date of U.S. Provisional Application No. 61/137,637, filed Aug. 1, 2008, the disclosure of which is incorporated, in its entirety, by reference.

### TECHNICAL FIELD

The present disclosure relates to wind turbines generally, and more specifically relates to power control systems and methods in vertical axis wind turbines.

### BACKGROUND

Wind turbines are used for electrical energy generation because of their economical power production and potential environmental benefits. Large wind turbines located in off shore or remote wind farms are increasingly being installed worldwide. Wind turbines can produce megawatts of electric power, consume little non-renewable energy resources, and have low pollution ramifications.

Another application for wind turbines is in small wind turbines, typically of 10 kilowatts peak power or less. Such small wind turbines have been deployed on farms for use in, for example, pumping water for irrigation and stock watering, and providing some electricity production. Use of small wind turbines has generally been limited. An additional emerging market opportunity for small wind turbines is in urban and suburban installations. In these installations, customers use small wind turbines to produce some of their own electric power and offset their utility bills through net metering. Urban and suburban wind turbines are typically located where people live, with installations on rooftops, in yards and along roadsides. Small wind turbines can reduce electricity transmission losses and the need for increased transmission lines.

One type of wind turbine, which may be constructed either as large or small sizes, is vertical axis wind turbines. Vertical axis turbines or cross-wind turbines have rotors that rotate about a vertical axis. One advantage of vertical axis wind turbines is that they readily capture and convert wind energy from changing direction and turbulent wind. Darrieus type turbines (also know as egg beater turbines) are the most common vertical axis turbines. Darrieus type turbines are typically more efficient than other types of vertical axis turbines because they utilize lift of the rotor blades to extract energy from the wind.

In addition to using small wind turbines connected to a utility power grid to reduce electricity bills, small wind turbines are also used for directly driving DC loads and for charging batteries in off grid installations. Unique challenges exist in the generation and control of DC power generated by a small wind turbine.

### SUMMARY

One aspect of the present disclosure relates to a wind turbine having a wind turbine control system. The control system converts AC power generated by the wind turbine to DC power for use in a load. The control system may include a plurality of modules that convert the AC power to DC power. The control system may be configured to convert the DC power back to AC power depending on the load. The control system may include a turbine module that converts the AC power produced by a generator of the wind turbine to DC power. The turbine module may also include a boost converter that boosts the DC current to a higher voltage that improves efficient transfer of the DC power to the load. The control system may further include an output module having a buck converter that bucks the voltage of the DC power to a level needed for use by the load.

In at least one example, the load is a battery and the control system provides DC power from the wind turbine generator to the battery in a regulated state for use in charging the battery. The control system may further include bumping functionality that addresses rapid variations power generation by the wind turbine generator resulting from variations in the wind speed driving a rotor of the wind turbine.

The wind turbine may include a turbine rotor with multiple blades and a permanent magnet alternator in addition to the electronic controller. The turbine rotor drives the permanent magnet alternator in response to wind. The electronic controller controls the speed of the turbine rotor and the power from the permanent magnet alternator to the DC load.

The turbine module of the electronic controller may be located in proximity with the permanent magnet alternator. The output module may be located remote from the permanent magnet alternator and in proximity with, for example, the DC load. The turbine module may include a boost converter that boosts the voltage from the permanent magnet alternator for transmission to the output module. The output module may include a buck converter that bucks the voltage from the turbine module to provide a substantially constant voltage to the DC load. A maximum output voltage supplied to the DC load may be regulated by the output module. An instantaneous power supplied to the DC load may be regulated by the turbine module.

Another aspect of the present disclosure relates to a method of power control in a wind turbine. The wind turbine includes a rotor, an alternator coupled to the rotor, and an electronic controller. The method may include exposing the rotor to wind to rotate the rotor, generating AC power with the alternator upon rotation of the rotor, converting the AC power to DC power with the electronic controller, boosting the DC power to a higher voltage with the electronic controller, delivering the boosted DC power to a load, and bucking the boosted DC power with the electronic controller to a voltage level usable by the load.

The electronic controller may include a turbine module configured to convert the AC power to DC power and boost the DC power. The electronic controller may include a output module that bucks the boosted DC power, the output module being located in proximity to the load. The method may further comprise controlling an amount of AC power generated by the alternator with the electronic controller based on a power demand of the load. The method may also include slowing rotation of the rotor with the electronic controller upon increase of a rotation speed of the rotor above a threshold level. The method may include regulating the boosted DC power to provide a constant DC output to the load. The load may be positioned at a location remote from the alternator, and the electronic controller may be configured to minimize DC power loss in delivering power to the load. The load may be a battery, and the method may further include charging the battery with the bucked DC power.

Additional advantages and novel features will be set forth in the description which follows or may be learned by those skilled in the art through reading these materials or practicing the examples disclosed herein.

### BRIEF DESCRIPTION OF THE DRAWINGS

The accompanying drawings illustrate various embodiments and are a part of the specification. The illustrated embodiments are merely examples and do not limit the scope of the present disclosure.

FIG. 1 is a schematic side view of a residential installation of an example wind turbine in accordance with the present disclosure.

FIG. 2 is a schematic cross-sectional side view of an example generator and turbine module for use in the wind turbine shown in FIG. 1.

FIG. 3 is a schematic side view of a portion of an example output module and load for use with the wind turbine shown in FIGS. 1 and 2.

FIG. 4 is a schematic diagram showing an example wind turbine power system.

FIG. 5 is a plot of an example power versus tip speed ratio during a wind-limited operating condition.

FIG. 6 is a plot of an example power versus tip speed ratio during a load-limited operating condition.

FIG. 7 is a plot of an example power versus tip speed ratio during an above-rated-wind-speed operating condition.

FIG. 8 is a schematic diagram showing an example alternate configuration of turbine power system.

FIG. 9 is a plot of an example wind speed versus RPM during a load-limited operating condition.

FIG. 10 is a plot of an example power versus RPM for a wind turbine.

FIG. 11 is a plot of an example relative variation of transmission voltage, voltage to load, and power to load for a wind turbine.

FIG. 12 is an example graph comparison of transmission loss for a prior art wind turbine.

FIG. 13 is an example graph comparison of annual energy generation for a prior art wind turbine.

Throughout the drawings, identical reference numbers designate similar, but not necessarily identical, elements.

### DETAILED DESCRIPTION

The present application is directed to wind turbines such as vertical axis wind turbines. Power generated by the wind turbine may be regulated and transferred to a load. The wind turbine may be controlled to prevent excess generation in high winds or when driving small loads. A small wind turbine system may be configured to maximize the amount of renewable energy generation that is supplied over time.

The present disclosure relates to wind turbines and related power generation and power control methods that produces regulated direct current (DC) power for loads that are electrically connected to the wind turbine. Preferably, the wind turbine operates with relatively high efficiency and turbine energy generation. The wind turbine may afford safe and reliable operation with a low cost construction and installation.

The wind turbine typically comprises a turbine rotor with multiple blades, a permanent magnet alternator, and an electronic controller. The permanent magnet alternator may be part of a generator unit or system of the wind turbine. The turbine rotor drives the permanent magnet alternator in response to wind contacting the turbine rotor. The electronic controller controls the speed of the turbine rotor and the power from the permanent magnet alternator to the DC load.

The electronic controller may include a turbine module and an output module. The turbine module may be located in proximity with the permanent magnet alternator. The output module may be located remote from the permanent magnet alternator and may be located in proximity with the DC load. The turbine module may include a boost converter that boosts the voltage from the permanent magnet alternator for transmission to the output module. The output module may include a buck converter that bucks the voltage from the turbine module to provide a substantially constant voltage to the DC load. The maximum output voltage supplied to the DC load may be regulated by the output module. The instantaneous power supplied to the DC load may be regulated by the turbine module.

The DC load may be, for example, lights such as grow lights, batteries, or other loads that do not require alternating current (AC) power. The energy from the wind turbine is used to power the load, such as powering lights or charge a battery or battery string. A battery string may be wired in series to provide more steady and reliable power to drive other loads and accept variable power production from the wind turbine.

The wind turbine is typically configured to produce as much energy annual as possible for use by the load. The wind turbine may adjust operation as the speed of the wind varies up and down to maximize power generation. In some embodiments, the electronic controller controls the turbine rotor to approximately track the peak power coefficient for the rotor when the DC load is able to utilize more power than the wind turbine is capable of providing from the available wind.

In some arrangements, the available energy from the wind may be greater than the load can handle. This scenario may occur during a wind storm or when the load cannot accept further power (e.g., batteries are near fully charged). To accommodate this occurrence, the electronic controller may function to control the turbine rotor (e.g., via the wind turbine generator) to operate at a tip speed ratio that is lower than the tip speed ratio corresponding to the maximum power coefficient when the power available from the wind is greater than the power that the DC load can utilize. The electronic controller may be capable of causing the rotor to rotate at a slower speed relative to the wind speed such that the rotor looses aerodynamic efficiency and extracts less energy from the wind. The wind turbine can operate to reduce the power delivered to the load when the load cannot utilize more power. When the load consists of a battery, the wind turbine can be operable limit overcharging of the battery.

In one example, the electronic controller loads the permanent magnet alternator to create a back electromotive force (back EMF) that opposes rotation of the rotor such that the turbine rotor operates at a lower tip speed ratio than the tip speed ratio corresponding to the maximum power coefficient when the power available from the wind is greater than the power that the battery can accept without overcharging the battery.

The turbine module may be connected to the output module by a plurality of transmission wires. Boosting of the voltage from the turbine module reduces the current and the transmission losses. Boosting further allows use of smaller and more cost effective transmission wires for supplying the turbine power to the load. With the output module located at the load, it may provide highly accurate voltage regulation at the point of use, thereby preventing undercharging or overcharging potential.

In yet another embodiment, the transmission wires transmit both the power and control the variation of the voltage to the DC load below the maximum voltage set by the output module. By having the power control in the turbine module, safety may be increased because a loss of the transmission connection is less likely to enable the turbine to operate uncontrollably or have an over speed event. Control of the variation of the voltage to the DC load may be provided by a variation of the voltage on the transmission wires. Alternatively, a frequency signal down the transmission wires may also be used to control the variation of the voltage to the DC load below the maximum set by the output module.

The boost and buck converters of the electronic controller may cooperate to regulate the steady state operation of extraction of energy from the wind and supply of regulated power to the load. During rapidly changing wind speeds, there is a potential for the speed of the turbine rotor to exceed its rotational limit prior to the converters response to adjust the equilibrium. This may also occur if there is a sudden loss in the DC load. In one embodiment, the turbine rotor is protected from over speeding by absorbing power from wind gusts. The turbine module may further include a separate dump circuit that absorbs instantaneous excess power from the permanent magnet alternator to prevent over speeding of the turbine rotor resulting from wind gusts. The dump circuit preferably prevents transmission of the instantaneous excess power to the output module. The dump circuit may be simply activated when the speed of the rotor nears its allowable limit, such that alternator power is dissipated in a brake load in the turbine. Unlike wind turbines that continuously dissipate all wind energy extracted above the ability of the load, the dump circuit is only used to absorb transient spikes from gusts and hence may be made relatively small.

The wind turbine may be utilized with any type of wind turbine, such as the small wind turbines disclosed above that capture wind energy through the use of aerodynamic lift of a turbine rotor. One preferable type of small wind turbine that may be useful in widespread locations is a vertical axis cross-wind rotor. A well-known version of vertical axis turbine is a Darrieus type rotor. Darrieus turbines may increase annual power generation as compared to other types of rotors because they can readily generate power from any direction of wind. Darrieus type rotors may operate at lower tip speed ratios than propeller turbines, which can make them quieter in comparison to other types of rotors.

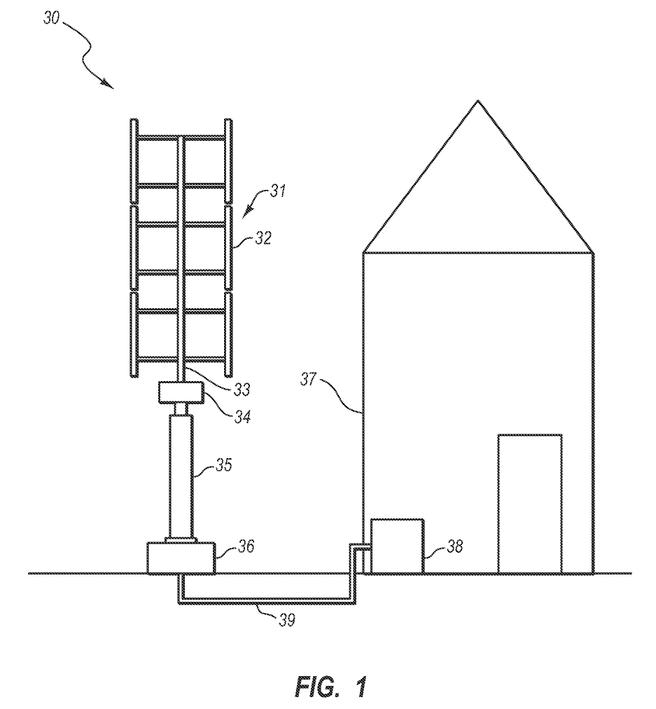

Turning to the drawings, FIG. 1 shows an example residential installation of a wind turbine in accordance with the present disclosure. The installation 30 may include a small wind turbine 31. The turbine 31 may include an airfoil rotor 32 having multiple vertically spaced tiers of multiple airfoils that are spaced uniformly around the vertical axis of the rotor. The airfoils are attached by struts to a center shaft 33 and drive the center shaft 33. The center shaft 33 is connected to a permanent magnet alternator 34. The alternator 34 is supported by a base pole 35 that is mounted on a concrete foundation 36. The wind turbine 31 provides power to a DC load, such as an off-grid house 37. Batteries 38 may be located in the house 37 to store energy from the wind turbine 31 and provide a source of stored power when needed. A transmission line may 39 connect the alternator 34 of the wind turbine 31 to the batteries 38.

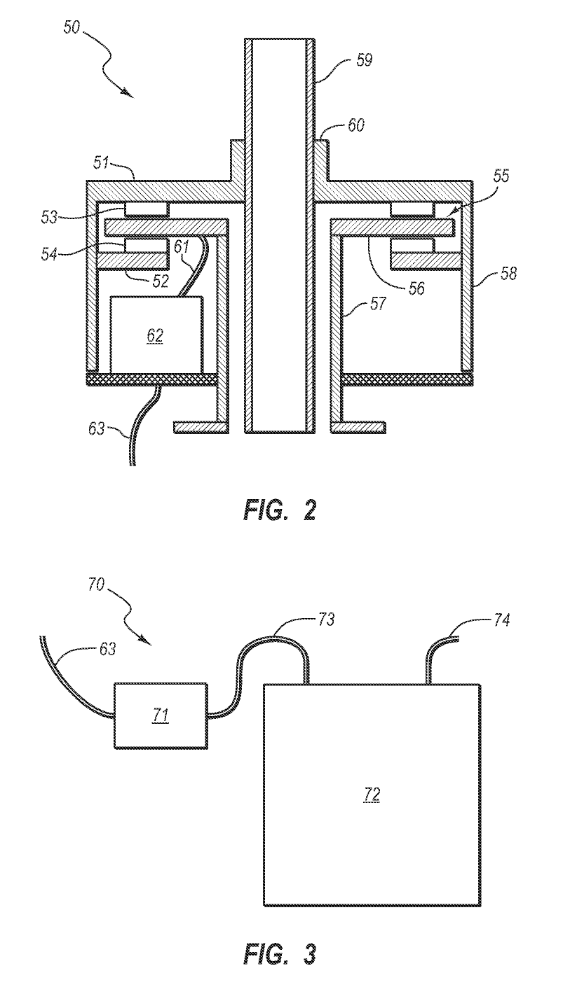

A generator 50 and a turbine module 62 for use in a wind turbine such as that shown in FIG. 1 is shown in FIG. 2. Many designs of permanent magnet alternators and related power generators may be utilized with the wind turbines disclosed herein. One type of high efficiency permanent magnet alternator is an air core design. An air core design can reduce magnet induced losses and cogging torque.

The alternator 50 is comprised of two steel back irons 51 and 52. The back irons 51, 52 may each hold a circumferential array of alternating axial polarity magnets 53, 54. The magnets 53, 54 drive magnetic flux back and forth across an armature airgap 55. An air core armature 56 may be located in the airgap 55 and supported by the alternator stator 57. The two back irons 51, 52 may be enclosed by an outer housing 58 that couples to the turbine shaft 59 through the use of a collar clamp 60. Power wires 61 from the air core armature 56 may connect to the turbine module 62. The turbine module 62 boosts the voltage from the armature 56 to provide higher voltage to the transmission line 63.

With reference to FIG. 3, an output module and battery for use in a wind turbine is shown. A power system output end 70 is comprised of an output module 71 that receives power from the transmission line 63, and provides charging power on a line 73 to a battery 72. The output module 71 may buck the voltage from the transmission line 63 and provides a regulated float voltage on the line 73. The battery 72 may provide power to an electrical load connection via line 74 for regulated use.

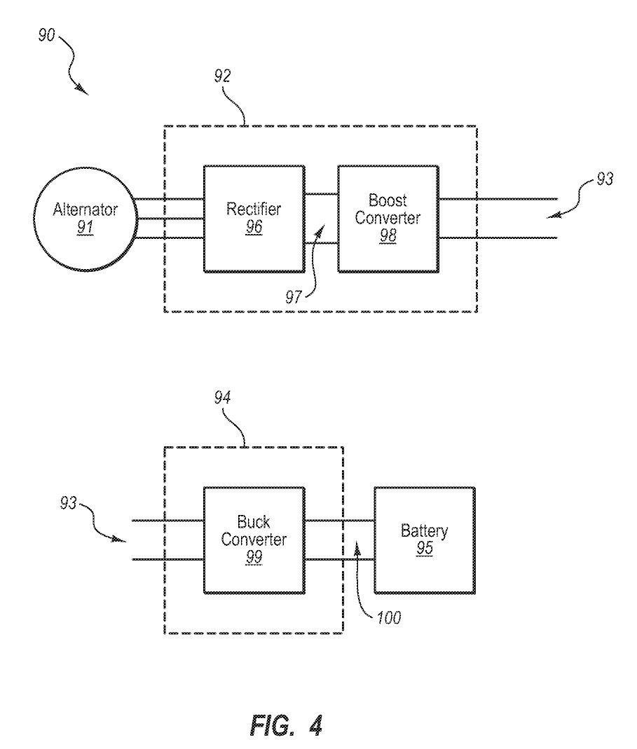

The power system of a wind turbine for us in the wind turbines shown in FIGS. 1-3, is shown in FIG. 4. The power system 90 includes a permanent magnet alternator 91, such as the alternator 50 in FIG. 2. The alternator 91 provides power to the turbine module 92 in response to wind energy driving the wind turbine. The turbine module 92 may output boosted transmission voltage to the transmission wires 93. The turbine module 92 includes a rectifier 96 that converters AC power from the alternator into direct current on lines 97. A boost converter 98 boosts the direct current on lines 97 to a higher transmission voltage on lines 93 for reduced transmission losses.

Located remote from the alternator 91 and adjacent the DC load 95, an output module 94 converts the power from the transmission line 93 into regulated power on lines 100 that charges power the load (e.g., a battery 95). The output module 94 comprises a buck converter that reduces the voltage to that which is needed for battery charging. Preferably, the output module 94 has different customer float voltage settings such that different voltage battery strings may be utilized. The output module 94 typically limits the maximum voltage that is supplied to the battery 95. The turbine module 92 may control the power that is supplied to the battery 95 through control of the operating point of the turbine alternator 50 and variation of the output voltage 100 supplied to the battery below the maximum float setting of the output module 94.

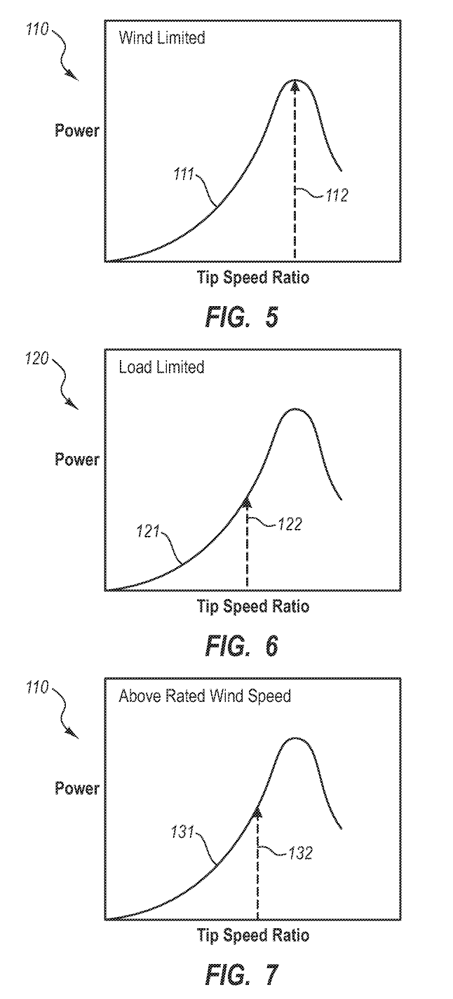

A plot 110 of power versus tip speed ratio during a wind-limited operating condition for an example wind turbine such as that shown in FIGS. 1-4 is shown in FIG. 5. In a wind-limited operating condition, there is less power available in the wind than the load can utilize. This may occur when there is only low wind and or when the batteries are discharged. In this case, the wind turbine preferably operates the turbine rotor to track the peak power coefficient for maximum energy extraction from the wind. The turbine modules 71, 92 can monitor the speed of the rotor 31 from the frequency of the alternator power, and control the amount of power supplied through the output module 94 to the battery 72, 95 to a value that corresponds to the maximum power coefficient for the turbine rotor speed. The amount of power to the battery is adjusted by the turbine module 62, 92 and output module 71, 94 adjusting the level of the output value, regardless of the voltage from the alternator. The higher the wind turbine increases the voltage above the alternator voltage and supplies to the battery, the greater the power that is transferred from the alternator 34, 91 to the battery 72, 95. The power versus tip speed ratio curve 111 may have a peak value 112 of maximum power coefficient for the rotor. This typically occurs at a specific tip speed ratio for the rotor.

A plot 120 of power versus tip speed ratio during a load-limited operating condition for an example wind turbine in accordance with the present disclosure is shown with reference to FIG. 6. In this load-limited operating condition, the wind turbine 30 may have more wind power available than the battery or other DC load can utilize. This may occur when there is a good wind or when the batteries are near fully charged. The turbine rotor 31 is stalled by the wind turbine such that the rotor operates at a reduced tip speed ratio on the power versus tip speed ratio curve 121. The operating point 122 thereby reduces the energy extraction of the rotor from the wind and the energy capture matches the utilization capability of the load.

A plot 130 of power versus tip speed ratio during an above-rated-wind-speed operating condition for a wind turbine accordance with the present disclosure is shown in FIG. 7. The wind turbine has a rated power and corresponding rated wind speed. The rated power is the maximum power that the wind turbine may produce and the rated wind speed is the speed of the wind at which rated power is achieved. In winds above rated wind speed, the wind turbine stalls the turbine rotor to the rotor energy extraction from the available wind. The rotor operates at a reduced tip speed ratio on the power versus tip speed ratio curve 131. The operating point 132 reduces the energy capture so that it matches the rated power or utilization capability of the load, whichever is currently less.

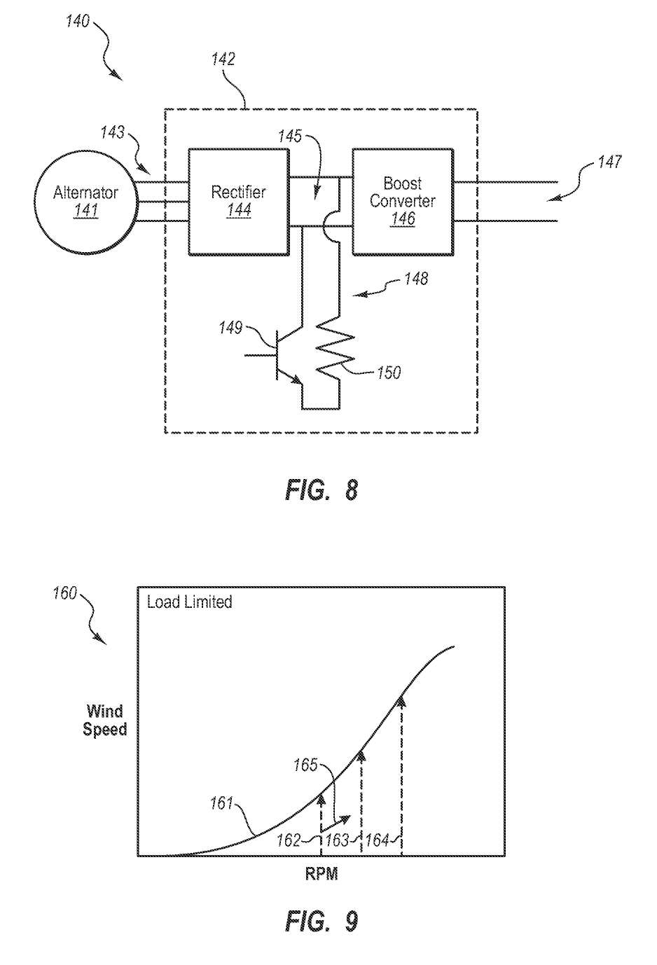

A schematic drawing of an alternate configuration of turbine-side power system or turbine module of wind turbine in accordance with the present disclosure is shown with reference to FIG. 8. The power system 140 may include a permanent magnet alternator 141 that is driven by the turbine rotor and produces, for example, unregulated 3 phase AC alternator power in lines 143 (corresponding to the line 61 in FIG. 2). The alternator power in lines 143 is regulated by the turbine module 142 (corresponding generally to the to the turbine module 62 in FIG. 1) to the transmission wires 147.

The turbine module 142 may include a rectifier 144 (corresponding to the rectifier 96 in FIG. 4) and a boost converter 146 (corresponding to the boost converter 98 in FIG. 4). The turbine module 142 rectifies and boosts the voltage to the transmission wires 147. The rectifier 144 and boost converter 146 may be combined. Alternatively, the rectifier 144 and boost converter 146 may have a revered order so long as the turbine module 142 provides needed rectification and boosting of the alternator voltage.

The turbine module 142 and output module 94 (shown in FIG. 4) may effectively cooperate to regulate the turbine operation and power supplied to a battery or DC load during steady state conditions. During transient conditions such as wind gusts, the load may not be able to accept the instantaneous excess power from the turbine to re-adjust the operating point of the rotor speed. In this case, the turbine rotor may have the potential to over speed. To prevent an over speed condition, a separate dump circuit 148 may be provided at the turbine to absorb instantaneous excess power. The dump circuit 148 may comprise a transistor 149 or other switching capability and a dump resistance 150 (e.g., a shorting wire). The dump circuit 148 may be activated by triggering the transistor 149 with a suitable sensor whenever the rotor speed nears its allowable limit and disengage when the rotor speed falls back to the normal acceptable operating range.

A plot of wind speed versus RPM during a load-limited operating condition for a wind turbine accordance with the present disclosure is shown with reference to FIG. 9. The plot 160 shows that rotor RPM 161 increases with increasing wind speed. In a steady state operating point 162, the rotor speed is limited to reduce the power to the load to the amount that the load can utilize. A wind gust 165 produces a transient condition that increases the rotor speed to a high speed operating point 163. The wind power extracted and provided to the rotor can remain constant by control of the turbine module 142. If the wind gust 165 continues, the rotor will continue to accelerate. Eventually, the rotor speed will near its maximum allowable speed 164. At this speed, the dump circuit in the turbine module may be activated to absorb the instantaneous excess power from the wind gust. The activation of the dump circuit will slow the rotor RPM and limit the occurrence of an over speed condition.

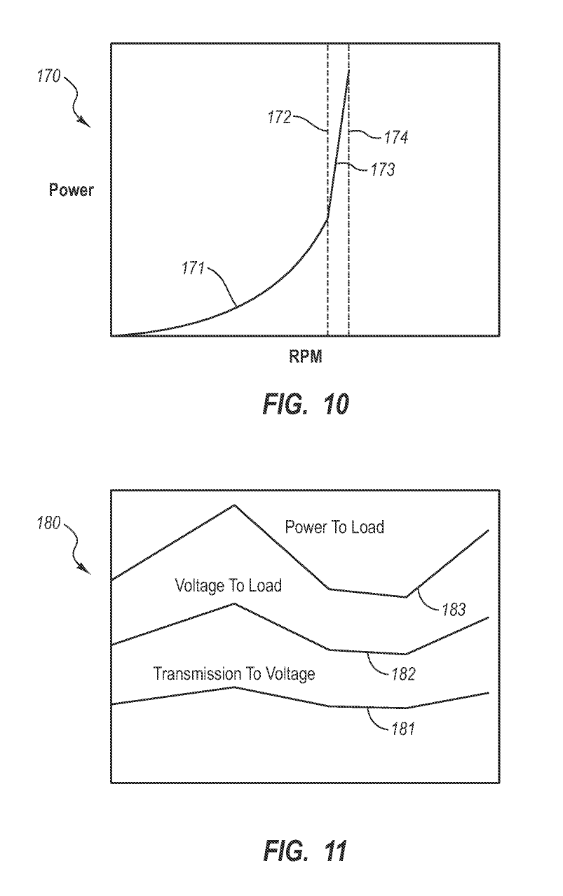

A plot of power versus RPM instruction for a wind turbine accordance with the present disclosure is shown with reference to FIG. 10. A wind turbine control of the rotor power regulation is shown by the power versus RPM curve 170. The curve 170 is designed for the specific turbine rotor based upon the aerodynamic performance of the rotor. The curve shown in FIG. 10 illustrates a function of the turbine and may be programmed into the turbine module 142. In wind-limited conditions, the power per RPM supplied to the load is controlled to match the peak power tracking curve 171. The peak power tracking curve 171 maintains the turbine rotor loading such that it provides the maximum potential power for the rotational speed. In conditions where the wind speed is above a threshold maximum rated speed condition, the rotor may be stalled with a steep power ramp 173. The ramp 173 starts when rated power 172 is achieved. If the rotor speed continues to increase to the maximum allowable speed 174, then the dump circuit 148 may be activated to limit occurrence of an over speed condition.

A plot of example relative variations of transmission voltage, voltage to load, and power to load for a wind turbine accordance with the present disclosure is shown with reference to FIG. 11. The output module 94 may set the maximum float voltage for charging the battery or driving the DC load. However, the turbine module 92, 142 may control the power transferred to the load by varying the voltage from the output module to be below the maximum set by the output module. One method for the turbine module to control the output module is through some variation of the transmission voltage. The transmission voltage 181 is raised and lowered to control the power transfer. The output module receives the variation in the transmission voltage and varies the voltage to the load 182 accordingly. As a result of variations of the voltage to the load 182, the power to the load 183 is also varied.

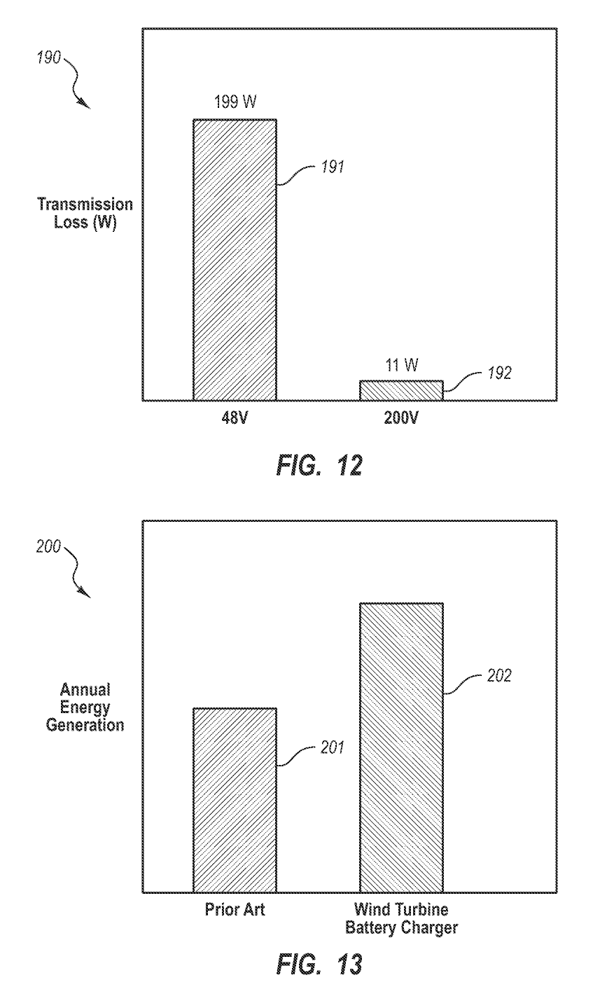

One advantage of the example wind turbines disclosed herein is a reduction of the power loss from transmission from the turbine to the battery. A comparison of transmission loss for a wind turbine of prior art with a wind turbine accordance with the present disclosure is shown in FIG. 12. The chart 190 compares a 48 volt wind turbine with a wind turbine utilizing a 200 volt transmission line. Both turbines are rated at 1200 watts and have a 100 foot distance between the turbine and the battery that is wired with 12 AWG wire. The 48 volt turbine loses 199 watts in transmission. The wind turbine loses only 11 watts from transmission. Another important benefit is that the voltage regulation to the battery is much more accurate for the wind turbine since it is regulated by the output module that is located in proximity with the battery.

A comparison of annual energy generation for a wind turbine of prior art with a wind turbine accordance with the present disclosure is shown in FIG. 13. Wind turbines that utilize an alternator and voltage regulator as the sole means of voltage control for charging batteries typically do not operate optimally. In low wind conditions, such configurations may fail to provide any charging power. In high winds, such configurations may sink large amounts of energy in an energy dump load. In normal wind speeds, such configurations may not accurately loaded to track the peak power coefficient for the turbine rotor.

The chart 200 shown in FIG. 13 compares the annual energy generation for a typical small wind turbine 201 with the wind turbine 202. The wind turbine may provide as much as a 30% to 50% increased annual energy generation, depending on the installation wind regime and turbine parameters. This production is additive on top of the reduced transmission losses from the connection between the turbine and batteries discussed above.

It can thus be seen that the embodiments described above may provide many advantages such as, without limitation:
Generating a power supply with a wind turbine and delivering the power supply as DC power to a load with minimal loss due to boosting the DC power at the wind turbine and bucking the DC power at the load.
Providing regulated DC power to a load from a wind turbine with high efficiency and providing concurrent maximum energy generation with the wind turbine.
A wind turbine that includes an electronic controller having a turbine module that converts AC power generated by the wind turbine to DC power and boosts the DC power to a higher voltage prior to transmitting the DC power to a remotely located load to decrease power loss during transmission.
An electronic controller of a wind turbine includes an output module located in proximity to a DC load, wherein the output module bucks a boosted DC power to a voltage useful for the load.
An electronic controller of a wind turbine that regulates a DC power on location at a load to provide a substantially constant DC power supply to the load regardless of variations in the DC power provided to the electronic controller.
An electronic controller of a wind turbine that controls power output of the wind turbine based on the power needs of the load.

The preceding description has been presented only to illustrate and describe exemplary embodiments of the present disclosure. It is not intended to be exhaustive or to limit the present disclosure to any precise form disclosed. Many modifications and variations are possible in light of the above teaching. It is intended that the scope of the present disclosure be defined by the following claims.

What is claimed is:

1. A wind turbine, comprising:
a rotor;
an alternator driven by the rotor to generate AC power;
an electronic controller configured to convert the AC power generated by the alternator to DC power, boost a voltage of the DC power, and buck the boosted DC power prior to delivery to a load.

2. The wind turbine of claim 1, wherein the rotor includes multiple blades, and the alternator is a permanent magnet alternator.

3. The wind turbine of claim 2, wherein the rotor drives the permanent magnet alternator in response to wind, and the electronic controller controls the speed of the rotor and the power from said permanent magnet alternator to the load.

4. The wind turbine of claim 1, wherein the electronic controller includes a turbine module and an output module, the turbine module is located in proximity with the alternator and the output module is located remote from the alternator and in proximity with the DC load.

5. The wind turbine of claim 4, wherein the turbine module comprises a boost converter that boosts the voltage from the alternator for transmission to the output module, and the output module comprises a buck converter that bucks the voltage from the turbine module to provide a substantially constant voltage to the load.

6. The wind turbine of claim 5, wherein a maximum output voltage supplied to the load is regulated by the output module, and an instantaneous power supplied to the output module is regulated by the turbine module.

7. The wind turbine of claim 1, wherein the load is a DC load that comprises a battery.

8. The wind turbine of claim 1, wherein the electronic controller controls the rotor to track a peak power coefficient for the rotor to determine when the DC load is able to utilize more power than the wind turbine is capable of providing from wind that drives the rotor.

9. The wind turbine of claim 1, wherein the electronic controller controls the rotor to operate at a tip speed ratio that is lower than a tip speed ratio corresponding to a maximum power coefficient when wind driving the rotor provides more power than an amount of power that the load can utilize.

10. The wind turbine of claim 4, wherein the turbine module is coupled to the output module by at least one transmission wire, and the electronic controller is configured to transmit power over the at least one transmission wire and control variations in the voltage to the load below a maximum voltage set by the output module.

11. The wind turbine of claim 4, wherein the turbine module further includes a dump circuit that absorbs instantaneous excess power from the alternator to limit over speeding of the rotor resulting from wind gusts.

12. The wind turbine of claim 1, wherein the rotor is a Darrieus type rotor.

13. The wind turbine of claim 1, wherein the rotor comprises a vertical axis cross-wind rotor.

14. A method of power control in a wind turbine, comprising:
providing a wind turbine having a rotor, an alternator coupled to the rotor, and an electronic controller;
exposing the rotor to wind to rotate the rotor;
generating AC power with the alternator upon rotation of the rotor;
converting the AC power to DC power with the electronic controller;
boosting the DC power to a higher voltage with the electronic controller;
delivering the boosted DC power to a load;
bucking the boosted DC power with the electronic controller to a voltage level usable by the load.

15. The method of claim 14, wherein the electronic controller includes a turbine module configured to convert the AC power to DC power and boost the DC power.

16. The method of claim 15, wherein the electronic controller includes a output module that bucks the boosted DC power, the output module being located in proximity to the load.

17. The method of claim 14, further comprising controlling an amount of AC power generated by the alternator with the electronic controller based on a power demand of the load.

18. The method of claim 14, further comprising slowing rotation of the rotor with the electronic controller upon increase of a rotation speed of the rotor above a threshold level.

19. The method of claim 14, further comprising regulating the boosted DC power to provide a constant DC output to the load.

20. The method of claim 14, wherein the load is positioned at a location remote from the alternator, and the electronic controller minimizes DC power loss in delivering power to the load.
